(19) United States
(12) Patent Application Publication
(10) Pub. No.: US 2008/0318114 A1
(43) Pub. Date: Dec. 25, 2008

(54) SEPARATOR FOR FUEL CELL AND ITS MANUFACTURING METHOD AND FUEL CELL STACK USING THE SEPARATOR

(76) Inventors: Jae-wook Lee, Suwon (KR); Keun-yong Lee, Suwon (KR); Chan-hee Park, Suwon (KR)

Correspondence Address: CHRISTIE, PARKER & HALE, LLP, PO BOX 7068, PASADENA, CA, 91109-7068, US

(21) Appl. No.: 12/103,819

(22) Filed: Apr. 16, 2008

(30) Foreign Application Priority Data
Jun. 19, 2007 (KR) 10-2007-0059974

(51) Int. Cl. H01M 2/14; H01M 2/00; H01M 8/10

(52) U.S. Cl. 429/34; 72/379.2; 29/623.1; 429/30

(57) ABSTRACT

A separator for a fuel cell, including: a plate; a first flow channel having a first depth on a first side of the plate; a first inlet hole coupled to the first flow channel; a first outlet hole coupled to the first flow channel; a second flow channel on a second side of the plate; a second inlet hole coupled to the second flow channel; a second outlet hole coupled to the second flow channel; and a bridge unit having a second depth less than the first depth at a region where a direction of flow of at least one of the first inlet hole or the first outlet hole and a direction of flow of the second flow channel cross.

### CROSS-REFERENCE TO RELATED APPLICATION

This application claims priority to and the benefit of Korean Patent Application No. 10-2007-0059974, filed on Jun. 19, 2007, in the Korean Intellectual Property Office, the entire content of which is incorporated herein by reference.

### BACKGROUND

1. Field of the Invention

The present invention relates to a separator for a fuel cell that is pressed into a single plate and employs a bidirectional flow channel, its manufacturing method, and a fuel cell stack using the separator.

2. Discussion of Related Art

A fuel cell is a power generation system for producing electrical energy through an electrochemical reaction of an oxidant and a fuel (e.g., a hydrocarbon-based fuel). A fuel cell can be a molten carbonate fuel cell (MCFC), a solid oxide fuel cell (SOFC), a polymer electrolyte fuel cell (PEFC), a phosphoric acid fuel cell (PAFC), an alkaline fuel cell (AFC), etc., depending on the kind of electrolytes being utilized.

In addition, the polymer electrolyte membrane fuel cell may be divided into a polymer electrolyte membrane fuel cell (referred to as a proton exchange membrane fuel cell, PEMFC) and a direct methanol fuel cell (DMFC), depending on the kind of fuels being used. Because the polymer electrolyte membrane fuel cell uses solid polymers as an electrolyte, the electrolyte does not cause the polymer electrolyte membrane fuel to corrode or evaporate, and the polymer electrolyte membrane fuel cell may have a high current density per unit area. In addition, the polymer electrolyte membrane fuel cell has been studied for use as a portable power supply for supplying power to automobiles, etc.; a distributed power supply for supplying power to dwelling houses, public buildings, etc.; and a small power supply for supplying power to electronic equipment, etc., because the polymer electrolyte membrane fuel cell has a higher output property and a lower operation temperature than other kinds of fuel cells. In addition, the direct methanol fuel cell can directly utilize liquid fuels such as methanol without using a fuel reformer, and it is suitable for portable or small power supplies because it operates at an operation temperature of less than 100° C.

The above-mentioned polymer electrolyte membrane fuel cell may be manufactured by laminating a plurality of membrane electrode assemblies (MEAs), including an anode electrode, a cathode electrode, a polymer electrolyte membrane interposed between the anode electrode and the cathode electrode, and a separator. In one embodiment, the separator coupled to one side of the anode electrode has a flow channel for supplying a fuel to the anode electrode and functions to transfer electrons, generated in the anode electrode, to external circuits; and the separator coupled to one side of the cathode electrode has a flow channel for supplying an oxidant to the cathode electrode and functions to transfer electrons to the cathode electrode, the electrons being transferred from the anode electrode through the external circuits.

A suitable separator that can be utilized in a fuel cell as described above should have suitable physical properties such as good electric conductivity, air tightness, corrosion resistance, mechanical strength, and good processability. One suitable material that can be utilized for a separator is high-density graphite. The high-density graphite can be manufactured to form a light-weight stack because it has good electric conductivity and high corrosion resistance, and also has a low density due to the presence of numerous inner pores, but it has a problem in that the stack has to be relatively thick to prevent (or block) mixing of reaction gases, which leads to an increased volume of the stack. Also, the high-density graphite has disadvantages in that it needs to be subjected to an expensive machining process when it is being molded, which accounts for at least 60% of the manufacturing cost of the polymer electrolyte membrane fuel cell, and it is difficult to mass-produce the polymer electrolyte membrane fuel cell having the high-density graphite separator.

A composite separator utilizing a polymer/carbon complex, or a metallic separator utilizing metals having a low electrical resistance and a good corrosion resistance have been envisioned as a replacement separator for the high-density graphite separator. The metallic separator has high electric conductivity and good mechanical properties. Therefore, it is envisioned that there is a need for a metallic separator having a suitable structure that can be utilized in a fuel cell system.

### SUMMARY OF THE INVENTION

Aspects of embodiments of the present invention are directed toward a metallic separator for a fuel cell in which both of its sides are utilized, and its manufacturing method.

Another aspect of an embodiment of the present invention is directed toward an inexpensive fuel cell stack that can be easily manufactured with a small size by utilizing a separator in which both of its sides are utilized by the fuel cell stack.

An embodiment of the present invention provides a separator for a fuel cell, including: a plate; a first flow channel having a first depth on a first side of the plate; a first inlet hole coupled to the first flow channel; a first outlet hole coupled to the first flow channel; a second flow channel on a second side of the plate; a second inlet hole coupled to the second flow channel; a second outlet hole coupled to the second flow channel; and a bridge unit having a second depth less than the first depth at a region where a direction of flow of at least one of the first inlet hole or the first outlet hole and a direction of flow of the second flow channel cross.

Another embodiment of the present invention provides a method for manufacturing a separator for a fuel cell, the method including: preparing an original plate having a constant thickness; preparing a first mold including a first uneven pattern having a depressed part and a raised part for forming a meandered bidirectional flow channel, and a first punch pattern for forming a fuel flow manifold and an oxidant flow manifold, and having a bridge unit at a region where a direction of flow of the fuel flow manifold and a direction of flow of the flow channel cross, the bridge unit having a smaller height than other regions of the raised part; preparing a second mold comprising a second uneven pattern and a second punch pattern corresponding to the first uneven pattern and the first punch pattern; placing the original plate between the first tool and the second tool; and pressing the first tool and the second tool under a constant pressure to press-mold the original plate.

Another embodiment of the present invention provides a fuel cell, including: a membrane electrode assembly including an anode electrode, a cathode electrode, and an electrolyte between the anode electrode and the cathode electrode; and a separator on a surface of the membrane electrode assembly, wherein the separator includes: a plate; a first flow channel with a first depth in a first side of the plate; a first inlet hole coupled to the first flow channel; a first outlet hole coupled to the first flow channel; a second flow channel in a second side of the plate; a second inlet hole coupled to the second flow channel; a second outlet hole coupled to the second flow channel; and a bridge unit with a second depth smaller than the first depth at a region where a direction of flow of at least one of the first inlet hole or the first outlet hole and a direction of flow of the second flow channel cross.

Another embodiment of the present invention provides a separator for a fuel cell, including: a plate; a first flow channel having a first depth on a first side of the plate; a first inlet hole coupled to the first flow channel; a first outlet hole coupled to the first flow channel; a second flow channel on a second side of the plate; a second inlet hole coupled to the second flow channel; a second outlet hole coupled to the second flow channel; and a bridge unit having a second depth less than the first depth at a region where the first flow channel and at least one of the first inlet hole or the first outlet hole are coupled.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a plan schematic view showing a first side of an anode metal separator that may be manufactured utilizing a press molding method.

FIG. 1B is a plan schematic view showing a side of a cathode metal separator that may be manufactured utilizing a press molding method.

FIG. 1C is a plan schematic view showing a second side of the anode metal separator as shown in FIG. 1A.

FIG. 2A and FIG. 2B are schematic views illustrating fuel cell stacks utilizing the metal separators, as shown in FIG. 1A and FIG. 1B.

FIG. 3A is a plan schematic view of a first side of a separator for a fuel cell according to an embodiment of the present invention.

FIG. 3B is a bottom schematic view showing the second side of the separator as shown in FIG. 3A.

FIG. 4 is a cross-sectional schematic view taken from a line I-I′ of the separator as shown in FIG. 3A.

FIG. 5A and FIG. 5B are schematic views illustrating methods for manufacturing a separator for a fuel cell according to an embodiment of the present invention.

FIG. 6 is a schematic view, taken from a line II-II′ of the separator as shown in FIG. 3A, illustrating a fuel cell stack utilizing the separator for a fuel cell according to an embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, when a first element is referred to as being “on” a second element, it can be directly on the second element or be indirectly on the second element with one or more intervening elements interposed there between. In addition, when a first element is described as being “coupled to” a second element, the first element may be not only directly coupled to the second element but may also be indirectly coupled to the second element via one or more intervening elements. Further, elements that are not essential to the complete understanding of the invention may be omitted for clarity. Like reference numerals designate like elements throughout the specification.

In the following descriptions, a metallic material refers to a composite material utilizing single metallic materials, alloy materials, or metals as conductive matters.

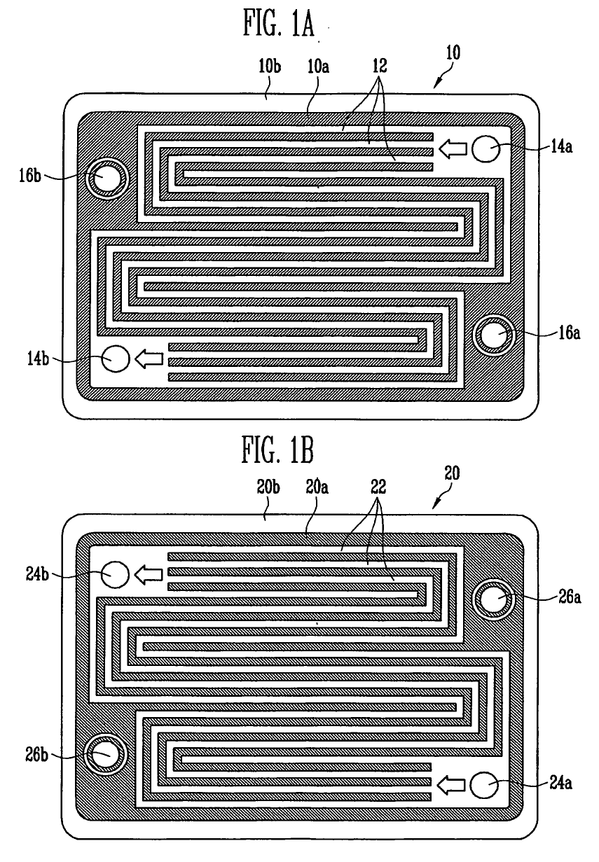

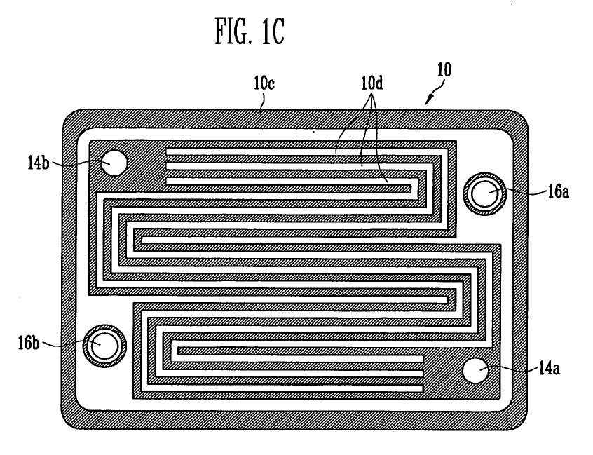

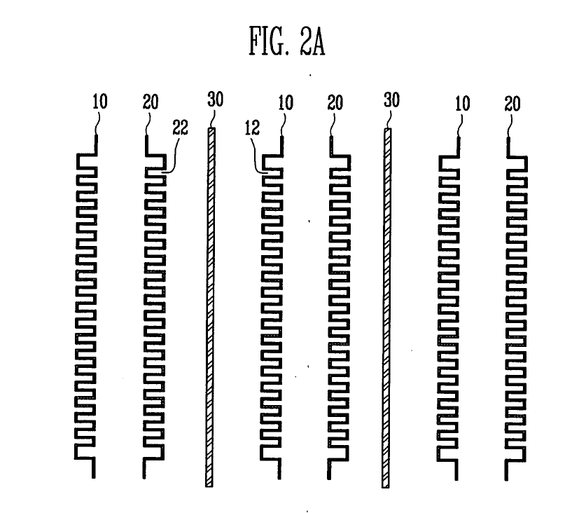

FIG. 1A is a plan schematic view showing a cross-section of an anode metal separator that may be manufactured utilizing a press molding method, FIG. 1B is a plan schematic view showing a cross-section of a cathode metal separator that may be manufactured utilizing a press molding method, and FIG. 1C is a bottom schematic view showing the anode metal separator as shown in FIG. 1A.

An anode metal separator 10 includes a fuel supply flow channel 12 in a first side thereof; a pair of fuel manifolds 14a, 14b coupled to both ends of the flow channel 12; and oxidant flow channels 16a, 16b separated from the flow channel 12, as shown in FIG. 1A. A cathode metal separator 20 includes an oxidant supply flow channel 22 in a side thereof; a pair of oxidant manifolds 24a, 24b coupled to both ends of the flow channel 22; and fuel flow channels 26a, 26b separated from the flow channel 22, as shown in FIG. 1B. In FIG. 1A and FIG. 1B, shaded regions represent raised parts 10a; 20a, respectively, and the remaining non-shaded regions represent depressed parts 10b; 20b, respectively. The raised parts 10a; 20a may be a region extruded into (or onto) a plane of the side, and the depressed parts 10b; 20b may be a surface that is nearly in contact (or level) with the plane of the side.

A second side of the anode metal separator 10 has a raised part 10c that is shaded; and a depressed part 10d that is not shaded, as shown in FIG. 1C. The depressed part 10d, which may be used as the fuel supply flow channel in the first side of the anode metal separator 10, may not be used as an oxidant supply flow channel since it is disconnected from the oxidant flow channels 16a, 16b. Similarly, the depressed part 10d may not be used as a fuel supply flow channel since it is disconnected from the fuel manifolds 14a, 14b in the second surface of the cathode metal separator 20.

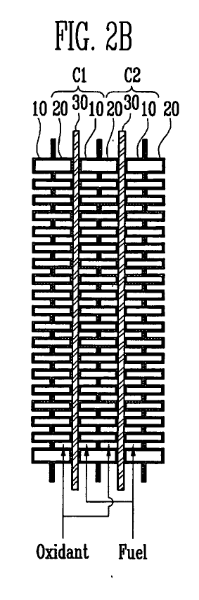

Thus, the above-mentioned fuel cell stack using a metallic separator manufactured by a press-molding method may be configured by laminating a plurality of single cells (C1, C2), as shown in FIG. 2A and FIG. 2B. Here, each of the single cells (C1, C2) may have a configuration where a first side of an anode metal separator 10 is on one surface of the membrane electrode assembly 30 and a first side of cathode metal separator 20 is on another surface of the membrane electrode assembly 30. Here, one anode metal separator 10 and one cathode metal separator 20 are installed so that they are between one membrane electrode assembly 30 and another adjacent membrane electrode assembly 30 while their second sides are in contact with each other. This fuel cell stack, using metal separators, is difficult to manufacture in a small stack since it is configured by inserting two sheets of the metallic separators 10, between the membrane electrode assemblies 30.

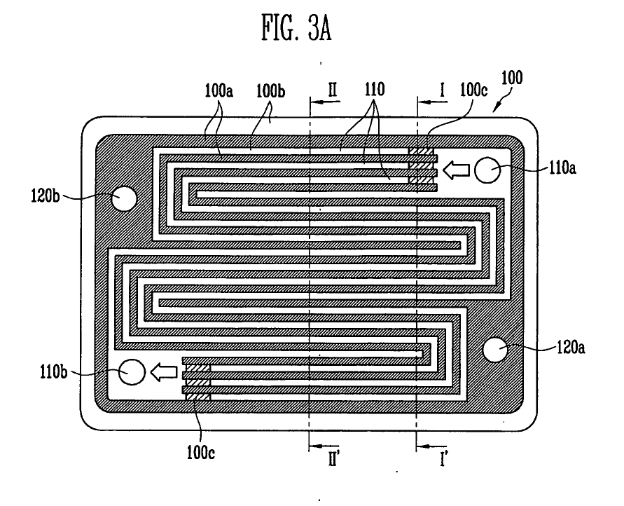

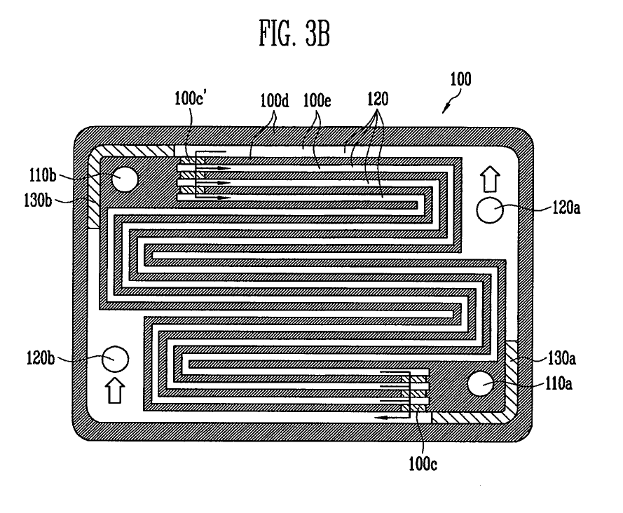

FIG. 3A is a plan view of a separator for a fuel cell according to one embodiment of the present invention, which solves the problem regarding difficulty in manufacturing the small separator for fuel cell.

Referring to FIG. 3A, the separator 100 for the fuel cell, according to an embodiment of the present invention, is composed of a single plate having a raised part 100a extruded onto (or into) one side by a press molding method; a depressed part 100b; and a plurality of punch portions formed by the press molding method.

The separator 100 is configured to use a bidirectional flow channel in a single plate by forming a region of the depressed part 100b into a bridge unit 100c at a region where flow directions of two flow channels cross each other, the bridge unit 100c being pressed in a direction where the raised part 100a is extruded. Accordingly, when seen from the one surface, the bridge unit 100c has a smaller depth than the other region of the depressed part 100b.

In this embodiment, a first flow channel 110, formed by regions of the depressed part 100b, is provided in a first side of the single plate of the separator 100. A first inlet hole 110a for enabling an inflow may be in one end of the first flow channel 110, and a first outlet hole 110b for enabling an outflow may be in another end of the first flow channel 110. The first inlet hole 110a may be referred to as an anode inlet-side fuel manifold for supplying a fuel to an anode electrode, and the first outlet hole 110b may be referred to as an anode outlet-side fuel manifold for transporting unreacted fuel and by-products flowing out from the first flow channel 110. The first flow channel 110 has three flow channels installed substantially parallel to each other in a meandering shape. The above-mentioned punch portions may include fuel manifolds 110a, 110b, oxidant flow channels 120a, 120b, and a coupling hole through which a coupling member for coupling a stack is passed.

FIG. 3B is a view of the second side of the separator 100 as shown in FIG. 3A.

Referring to FIG. 3B, the separator 100 is composed of a single plate including a raised part 100d extruded onto the second side thereof by a press molding method; a depressed part 100e; a bridge unit 100c′ installed in a region of the depressed part 100e; and a plurality of punch portions formed by a press molding method.

The raised part 100d of the second side corresponds to the depressed part 100b of the first side, and the depressed part 100e corresponds to the raised part 100a of the first side. Also, the bridge unit 100c′ of the second side corresponds to the bridge unit 100c of the first side.

A second flow channel 120 having a meandering shape and formed by the depressed part 100e is provided in the second side of the above-mentioned single plate constituting the separator 100. A second inlet hole 120a for enabling an inflow of a fluid is coupled to one end of the second flow channel 120, and a second outlet hole 120b enabling an outflow of a fluid is coupled to the other end of the second flow channel 120. The second inlet hole 120a corresponds to a cathode inlet-side oxidant flow manifold for supplying an oxidant to a cathode electrode, and the second outlet hole 120b corresponds to a cathode outlet-side manifold for transporting unreacted oxidant and by-products flowing out from the second flow channel 120.

When seen from the second side, the bridge unit 100c′ becomes a region having a lower height than other regions of the raised part 100d. The bridge unit 100c′ is installed in a region where a direction of flow of the first flow channel 110 formed in the first side of the single plate and a direction of flow of the second flow channel 120 formed in the second side of the single plate cross each other (i.e., a region where a direction of flow of the first inlet hole 110a of the first flow channel 110 crosses a direction of flow of the second flow channel 120 and a region where a direction of flow of the first outlet hole 110b crosses a direction of flow of the second flow channel 120, as shown in FIG. 3B). That is, the bridge unit 100c, 100c′ is at a region where the first flow channel 110 and the first inlet hole 110a are coupled. The bridge unit 100c, 100c′ may be used with the first flow channel 110 and the second flow channel 120, which are on opposite sides of the single plate.

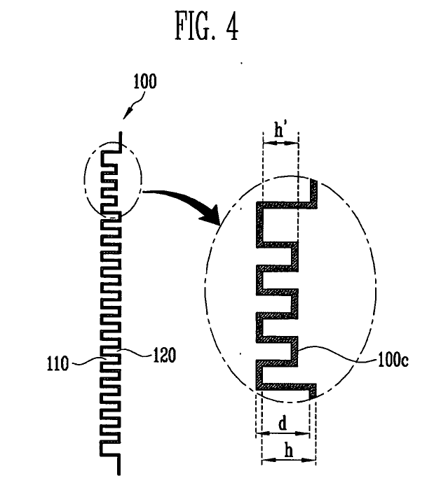

FIG. 4 is a cross-sectional view taken from a line I-I′ of the separator for a fuel cell, as shown in FIG. 3A.

Referring to FIG. 4, a height (h′) of the bridge unit 100c of the separator for a fuel cell 100 is set to a height level so that a fuel can easily move through the first flow channel 110 and an oxidant can easily move through the second flow channel 120. For example, when seen from the first side, the height (h′) of the bridge unit 100c may be about 3% to about 97% of a depth (d) of the depressed part 100b. Also, when seen from the second side, the height (h′) of the bridge unit 100c may be about 97% to about 3% of a height (h) of the raised part 100d.

Two flow channels that cross each other have a reduced unit area in the bridge unit, which leads to an obstacle to a flow of a fluid moving through the flow channels. Each of the flow channels formed in each side of the single plate should have bridge units in at least two regions, if parallel channels are formed as shown in FIG. 4.

The anode inlet-side flow channel (or manifold 110a), the anode outlet-side flow channel (or manifold 110b), the cathode inlet-side flow channel (or manifold 120a) and the cathode outlet-side flow channel (or manifold 120b) are present in the single plate in an embodiment of the present invention. The bridge unit 100c, 100c′ may result in one set of the flow channels (110a, 110b) having a decrease in its unit area, and the other set of the flow channels (120a, 120b) having an increase in its unit area. As a result, two of four flow channels have an increase in their unit area.

For some fuel cells whose fuel supply efficiency is an important factor, such as fuel cells using a liquid-phase cell (i.e., DMFC), the anode inlet-side flow channel and the anode outlet-side flow channel should have a decrease in unit area by the bridge unit, and the cathode inlet-side flow channel and the cathode outlet-side flow channel should have an increase in unit area.

In some other fuel cells, including polymer electrolyte membrane (PEM) fuel cells, an anode inlet-side flow channel and a cathode outlet-side flow channel should have a decrease in unit area, and a cathode inlet-side flow channel and an anode outlet-side flow channel should have an increase in unit area, which leads to improved fuel supply efficiency in the anode inlet-side flow channels and an improved by-product discharging efficiency in the cathode outlet-side flow channels.

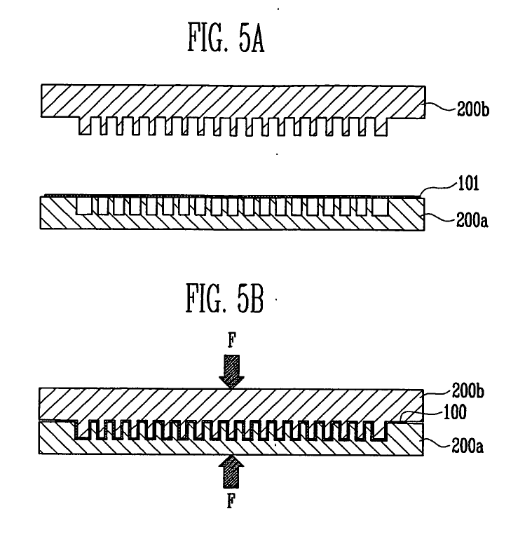

FIG. 5A and FIG. 5B are schematic views illustrating methods for manufacturing a separator for a fuel cell according to an embodiment of the present invention.

Referring to FIG. 5A and FIG. 5B, the separator for a fuel cell 100 may be manufactured by putting an original plate 101 having a constant thickness between the first mold 200a and the second mold 200b and press-molding the original plate 101 under a constant pressure (F).

The first mold 200a is prepared to have a first uneven pattern and a first punch pattern. The first uneven pattern has a depressed part and a raised part to form a meandered bidirectional flow channel, and the first punch pattern is to form fuel flow manifolds (or channels) and oxidant flow manifolds (or channels). Also, the first mold 200a is prepared to include a bridge unit having a smaller depth than other regions of the depressed part at an intersection of the bidirectional flow channels (and/or manifolds). The second mold 200b is prepared to have a second uneven pattern and a second punch pattern corresponding to the first uneven pattern and the first punch pattern of the first mold 200a.

Materials of the original plate 101 may include tantalum, niobium, titanium, magnesium, copper, aluminum, stainless steel, duralumin, etc., and alloys thereof, or metal powders including iron, nickel, chromium and nitrogen.

For PEM fuel cells, corrosion of the metallic separator is accelerated by functional groups (e.g., sulfonic groups (sulfonic acid)) that are present in a hydrogen ion exchange membrane. Then, metal oxides generated on a surface of the metallic separator function as an electric insulator to reduce electric conductivity, and metal cations dissociated at this time may contaminate a catalyst layer and a polymer electrolyte. As a result, performance of the fuel cell may deteriorate. However, a coating layer may be formed on a surface of the separator to solve these problems in an embodiment of the present invention.

For example, the separator 100 may be manufactured by coating a surface of the separator with gold, titanium nitride, lead oxide, carbon, and/or conductive polymer. The coating materials should have high conductivity, a high adhesion to the separator, and a low difference in a thermal expansion coefficient from the separator. The coating materials may be a multi-layered structure having at least two layers to improve corrosion resistance and adhesion.

A method for coating a surface of the separator with the above-mentioned coating materials, may include a gold topcoating layering, a stainless steel layering, a graphite topcoating layering, a titanium nitride layering, an indium doped tin oxide layering, a lead oxide layering, a silicon carbide layering, a titanium aluminum nitride layering, etc.

The metals/alloys that are described above that include stainless steel have suitable corrosion resistance since thin oxide films (i.e., passive thin films) are formed on their surfaces and function as protective layers against the corrosion of the oxide films, but the oxide films cause electrical resistance. Therefore, suitable metal/alloy materials, such as stainless steel that has high corrosion resistance, should be applied to the separator for fuel cell 100 according to the present invention. For example, it is possible to use stainless steel, such as 316L [10], 349 [7], 310 [6], etc.

A metallic separator 100 with both sides being usable may be manufactured, where the metallic separator 100 has suitable conductivity and corrosion resistance.

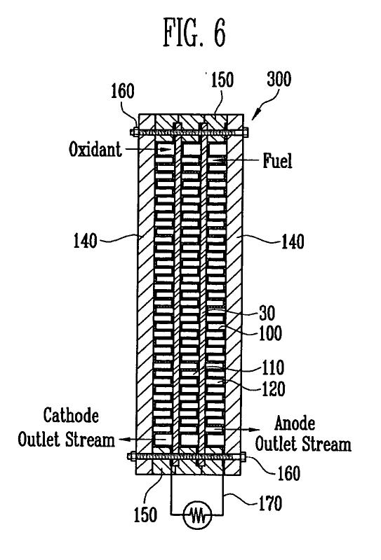

FIG. 6 is a schematic view illustrating a fuel cell stack utilizing the separator according to an embodiment of the present invention.

Referring to FIG. 6, the fuel cell stack 300 includes a membrane electrode assembly 30, a separator 100, a pair of end plates 140, a sealing member 150, and a coupling means 160. A cross-section of the separator 100 corresponds to the cross-section taken from a line II-II′, as shown in FIG. 3A.

According to this embodiment, the fuel cell stack 300 with the separator 100 has a reduced thickness, is light-weight, and is simpler to manufacture.

When the separator 100, according to the present invention, is installed in the above-mentioned fuel cell stack 300, flow channel interception members 130a, 130b are installed in a region of the depressed part 100e formed in the second side of the separator 100, as shown in FIG. 3B. The flow channel interception members 130a, 130b function so that a fluid (a fuel or an oxidant) flowing out from the second inlet hole 120a of the second surface can move toward the second outlet hole 120b through the second flow channel 120. The flow channel interception members 130a, 130b are made of materials having an elasticity (that may be predetermined) so that they can be tightly fit into a region of the depressed part 100e, and having a suitable corrosion resistance so that they cannot easily react with fluid in the stack 300 or cause corrosion. Materials, that may be used in the flow channel interception members 130a, 130b, include materials utilizing rubbers or polymers, for example ethylenepropylene rubber (EPDM), silicon, silicon-based rubber, acrylic rubber, a thermoplastic elastomer (TPE), etc.

The membrane electrode assembly 30 is composed of an electrolyte membrane; a cathode electrode disposed on one surface of the electrolyte membrane; and an anode electrode disposed on the other surface of the electrolyte membrane.

The electrolyte membrane has an ion exchange function to transport hydrogen ions, generated in the catalyst layer of the anode electrode, to the catalyst layer of the cathode electrode. The electrolyte membrane may be manufactured with a solid polymer, such as a hydrogen ion conductive polymer, having a thickness in a range from about 50 to about 200 μm (or 50 to 200 μm). The hydrogen ion conductive polymer may include a fluorinated polymer, a ketone polymer, a benzimidazole polymer, an ester polymer, an amide polymer, an imide polymer, a sulfone polymer, a styrene polymer, a hydrocarbon polymer, etc.

The anode electrode and the cathode electrode may have a catalyst layer and a diffusion layer. Here, the diffusion layer may be a microporous layer coated onto a backing layer. The catalyst layer may be materials such as platinum, ruthenium, osmium, platinum-ruthenium alloys, platinum-osmium alloys, platinum-palladium alloys, etc. The backing layer functions to support the catalyst layer, as well as to disperse fuel, water, air, etc., to collect generated electric current, and to prevent loss of the materials in the catalyst layer. The backing layer may be carbon materials such as carbon cloth, carbon paper, etc. The microporous layer functions to release by-products generated in the catalyst layer, as well as to uniformly disperse a fuel or an oxidant in the catalyst layer. The microporous layer may be at least one carbon material selected from the group consisting of graphite, carbon nanotube (CNT), fullerene (C60), activated carbon, Vulcan, Ketjen Black, carbon black, and/or carbon nano horn.

A pair of the end plates 140 has a plurality of ports coupled to the fuel manifold and the oxidant flow channel of the separator 100. The end plate 140 may include metals such as aluminum, alloys such as stainless steel, polymer composite materials such as plastics, ceramic composite materials, fiber-reinforced polymer composite materials, etc. If the end plate 140 has conductivity, the fuel cell stack 300 may have an end plate 140 whose at least one surface is coated with an insulator layer, or may further include an insulator disposed between the end plate 140 and the separator 100.

The sealing member 150 is disposed between edges of the membrane electrode assembly 30 and the separator 100, or between edges of the separators 100. The sealing member 150 prevents leakage of fuel supplied to the anode electrode of the membrane electrode assembly 30, and inflow of external air, etc., and prevents (or blocks) mixing of the fluids in the fuel cell stack 300. The sealing member 150 is made of materials having suitable elasticity and stress maintenance to the heat cycle, and it may be installed as a semi-cured gasket pad having a pattern (that may be predetermined), installed after it is coated with slurry materials and cured, or installed by a combination of two above-mentioned processes. The sealing member 150 may include rubber or materials using polymers, for example ethylenepropylene rubber (EPDM), silicon, silicon-based rubber, acrylic rubber, a thermoplastic elastomer (TPE), etc.

The coupling member 160 may be a bolt passed through a pair of the end plates 140; and a nut coupled to an end of the bolt. Other coupling means, widely known in the art, may be used as the coupling member 160, in addition to the bolt and the nut.

Operation of the fuel cell stack 300 will be described as follows.

A hydrogen containing fuel supplied from a fuel supply apparatus is oxidized while it is ionized into hydrogen ions (H⁺) and electrons (e⁻) through an electrochemical reaction in the anode electrode of the membrane electrode assembly 30. The generated hydrogen ions move to the cathode electrode through an electrolyte membrane, and the electrons move from the anode electrode to the cathode electrode through an external circuit 170. The hydrogen ions reaching the cathode electrode generate heat of reaction and water through the electrochemical reduction reaction with an oxidant (e.g., oxygen) supplied from the oxidant supply apparatus to the cathode electrode. The electrons required for the reduction reaction generate electrical energy while moving from the anode electrode to the cathode electrode.

Hydrocarbon-based fuels such as methanol, ethanol and butane gas, sodium borohydride (NaBH₄), pure hydrogen, etc. may be used as fuel. If methanol is used as fuel, then an electrochemical reaction of the fuel cell stack may be represented by the following Scheme 1.

### Scheme 1

Anode: CH₃OH+H₂O→CO₂+6H⁺+6e⁻

Cathode: 3/2O₂+6H⁺+6e⁻→3H₂O

Total: CH₃OH+3/2O₂→CO₂+2H₂O

If pure hydrogen or hydrogen-rich modified gases are used as the fuel, then an electrochemical reaction of the fuel cell stack may be schematically represented by the following Scheme 2.

### Scheme 2

Anode: H₂(g)→2H⁺+2e⁻

Cathode: ½O₂+2H⁺+2e⁻→H₂O

Total: H₂+½O₂→H₂O

A separator for a fuel cell, according to the present invention, has advantages in that a small and light-weight fuel cell stack may be easily mass-produced by employing a metallic separator that can use a bidirectional flow channel.

In another embodiment of the present invention, the bridge unit may be further installed in a region other than the region where the first flow channel and the second flow channel cross with each other, so as to facilitate a flow of the fluid passing through the flow channel.

The separator for a fuel cell, according to the present invention, may be useful to produce a small fuel cell stack and simplify its manufacturing process. In addition, the separator for a fuel cell according to the present invention may reduce the cost of fuel cells by lowering the manufacturing cost of the separator, which is about at least 60% of the manufacturing cost of the fuel cell stack at the present time.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A separator for a fuel cell, comprising:
a plate;
a first flow channel having a first depth on a first side of the plate;
a first inlet hole coupled to the first flow channel;
a first outlet hole coupled to the first flow channel;
a second flow channel on a second side of the plate;
a second inlet hole coupled to the second flow channel;
a second outlet hole coupled to the second flow channel; and
a bridge unit having a second depth less than the first depth at a region where a direction of flow of at least one of the first outlet hole or the first inlet hole and a direction of flow of the second flow channel cross.

2. The separator according to claim 1, wherein the second depth is in a range from about 97% to about 3% of the first depth.

3. The separator according to claim 1, wherein the bridge unit on the second side of the plate has a lower height than a height of the second flow channel.

4. The separator according to claim 3, wherein the height of the bridge unit on the second side of the plate is in a range from about 97 to about 3% of the height of the second flow channel.

5. The separator according to claim 1, wherein each of the first flow channel and the second flow channel comprises a plurality of channels.

6. The separator according to claim 1, wherein the plate comprises metals or alloys surface-coated with materials having suitable corrosion resistance.

7. A method for manufacturing a separator for a fuel cell, the method comprising:
preparing an original plate having a constant thickness;
preparing a first mold comprising a first uneven pattern having a depressed part and a raised part for forming a meandered bidirectional flow channel, and a first punch pattern for forming a fuel flow manifold and an oxidant flow manifold, and having a bridge unit at a region where a direction of flow of the fuel flow manifold and a direction of flow of the flow channel cross, the bridge unit having a smaller height than other regions of the raised part;
preparing a second mold comprising a second uneven pattern and a second punch pattern corresponding to the first uneven pattern and the first punch pattern;
placing the original plate between the first tool and the second tool; and
pressing the first tool and the second tool under a constant pressure to press-mold the original plate.

8. The method for manufacturing a separator according to claim 7, further comprising inserting a flow channel interception member in a region of the depressed part.

9. The method for manufacturing a separator according to claim 8, wherein the original plate comprises a metal selected from the group consisting of tantalum, niobium, titanium, magnesium, copper, aluminum, iron, nickel, chromium, nitrogen, and combinations thereof.

10. A fuel cell, comprising:
a membrane electrode assembly comprising an anode electrode, a cathode electrode, and an electrolyte between the anode electrode and the cathode electrode; and
a separator on a surface of the membrane electrode assembly,
wherein the separator comprises:
a plate;
a first flow channel with a first depth in a first side of the plate;
a first inlet hole coupled to the first flow channel;
a first outlet hole coupled to the first flow channel;
a second flow channel in a second side of the plate;
a second inlet hole coupled to the second flow channel;
a second outlet hole coupled to the second flow channel; and
a bridge unit with a second depth smaller than the first depth at a region where a direction of flow of at least one of the first inlet hole or the first outlet hole and a direction of flow of the second flow channel cross.

11. The fuel cell according to claim 10, wherein the second depth is in a range from about 97% to about 3% of the first depth.

12. The fuel cell according to claim 10, wherein the bridge unit on the second side of the plate has a lower height than a height of the second flow channel.

13. The fuel cell according to claim 12, wherein the height of the bridge unit on the second side of the plate is in a range from about 97 to about 3% of the height of the second flow channel.

14. The fuel cell according to claim 12, wherein the separator further comprises a flow channel interception member in a region of a depressed part of the second side of the plate.

15. The fuel cell according to claim 10, wherein each of the first flow channel and the second flow channel comprise a plurality of channels.

16. The fuel cell according to claim 10, wherein the plate comprises metals or alloys.

17. A separator for a fuel cell, comprising:
a plate;
a first flow channel having a first depth on a first side of the plate;
a first inlet hole coupled to the first flow channel;
a first outlet hole coupled to the first flow channel;
a second flow channel on a second side of the plate;
a second inlet hole coupled to the second flow channel;
a second outlet hole coupled to the second flow channel; and
a bridge unit having a second depth less than the first depth at a region where the first flow channel and at least one of the first inlet hole or the first outlet hole are coupled.
